(19) United States
(12) Patent Application Publication
(10) Pub. No.: US 2022/0396697 A1
(43) Pub. Date: Dec. 15, 2022

(54) CONDUCTIVE POLYMER COMPOSITION

(71) Applicant: Arctic Biomaterials Oy, Tampere (FI)

(72) Inventors: Ari ROSLING, Tampere (FI); Marjo KETONEN, Tampere (FI)

(21) Appl. No.: 17/774,353

(22) PCT Filed: Nov. 4, 2020
(86) PCT No.: PCT/FI2020/050729

§ 371 Date: May 4, 2022

(30) Foreign Application Priority Data
Nov. 5, 2019 (FI) 20195949

(51) Int. Cl. C08L 67/04; C08G 63/08; C08J 3/22; C08J 3/00; C08K 3/04; C08L 67/02

(52) U.S. Cl. CPC C08L 67/04; C08G 63/08; C08J 3/226; C08J 3/005; C08K 3/041; C08L 67/02; C08J 2367/04; C08J 2367/02; C08K 2201/001; C08K 2201/011; C08L 2205/025; C08L 2310/00; C08L 2203/20; C08L 2201/06

(57) ABSTRACT

The invention relates to a method for producing a polymer master batch and a polymer composition, wherein the method comprises providing at least one monomer capable of forming a poly(hydroxy carboxylic acid), providing a graphene nano-filler, mixing the monomer and the graphene nano-filler and letting the monomer polymerize in the presence of the graphene nano-filler. The polymer together with the graphene nano-filler is further blended with another polymer to form a polymer composite. The invention also relates to a polymer composition with graphene nano-filler and a composite material comprising a polymer composite with graphene nano-fillers.

### FIELD OF THE INVENTION

The present invention relates to a polymer composition and material and in particular to a composite comprising a biodegradable polymer that have been modified by incorporating graphene nano-fillers to impart electrical conductivity to the polymer. The present invention also relates to methods of making the polymer composition, which comprise graphene nano-filler and to uses of the polymer composition and material.

### BACKGROUND OF THE INVENTION

Polymeric materials are typically insulators and not electrically conductive. There are numerous ways of imparting electrical conductivity into polymers. Conductive components can be incorporated into the polymeric material to make the polymer conductive. It is essential that the conductivity of a polymer can be controlled by the incorporation of the conductive components and that the properties of the polymer is not compromised or reduced with the incorporated conductive components.

Conductive polymer materials are increasingly replacing metal materials in various fields such as electromagnetic interference (EMI) shielding, radio frequency interference (RFI) shielding, electrostatic discharge ESD and antistatic protection. Using conductive polymers for EMI, RFI, and EDS shielding provides weight reduction, reduced manufacturing steps thereby reducing costs. Polymeric materials also provide a greater freedom of design as compared with comparable metal-based solutions. Furthermore, the potentially enhanced heat transfer capability offers solutions in the electronic equipment sector where the small appliance size inhibits the use of other cooling systems. This potentially improved heat transfer is of great importance as plastics are the main component in e.g. cellphones, computers and various electronic equipment where heat sinks must be avoided.

The ever-growing concern of reduced raw oil resources and increasing plastic waste problems in the nature has strongly driven forward the development of bioplastic alternatives for applications in consumer goods and electronics. Bioplastics is a general term for plastics that are biodegradable and/or the monomer/polymer are completely or partially from sustainable renewable resources. The carbon footprint of bioplastics is generally considered to be substantially lower than similar fossil-based material. In addition, in case of biodegradable bioplastics, the biodegradation provides an additional alternative for end-of-life and recycling. Thus, biodegradation secures the degradation of the polymer into harmless water and carbon dioxide if e.g. the material accidently is released into the nature. However, there are better recycling options for biodegradable plastics than a natural mineralization (in landfill/soil/marine), though being carbon neutral. Biodegradable polymers can be re-used as material and recovered as monomer through depolymerization. With correct formulations many bioplastics can compete with traditional fossil-based technical plastics such as ABS, PC-ABS, PP and SAN amongst others, with regard to mechanical and thermal performance.

Conductive fillers that can be used to impart conductivity in polymeric materials are as such known. Publication WO 2013/141916 describe composite polymeric materials where conductive nano-fillers are used. The publication describe carbon nanotubes (CNT) as conductive fillers, which can be used to modify electric and electromagnetic characteristics of the composite polymeric material. The publication specifically describes a process for the production of a composition comprising a conductive nano-filler, a polyarylethersulphone thermoplastic polymer and an uncured thermoset resin precursor.

Patent publication WO 2016/018995 describe graphene-reinforced polymer matrix composites comprising a uniform distribution in a thermoplastic polymer of about 10% to about 50% of total composite weight of particles selected from graphite microparticles, single-layered graphene nanoparticles and multi-layered graphene nanoparticles. In addition, the publication discloses that addition of 1-2 wt-% graphene to a polymer matrix imparts electrical conductivity to the polymer.

However, there is still a lack of biodegradable bioplastics, which are also conductive. Especially, there is a lack of conductive bioplastics with same properties or enhanced properties compared to non-conductive bioplastics. The use of biodegradable polymers is highly dependent on their properties and affordability compared to their fossil-based alternatives. The industry and consumers will not change to biodegradable polymer materials unless they are cost effective and the properties are at least equally satisfiable compared to the fossil-based.

This invention provides a polymeric material, which is both biodegradable and electrically conductive. The properties of the conductive polymeric material are equal to the properties of the non-conductive material. Provided is also a cost effective method for producing a conductive biodegradable polymeric material with excellent dispersion and distribution of the conductive filler.

### BRIEF DESCRIPTION OF THE INVENTION

An object of the present invention is thus to provide a biodegradable polymer with conductive properties. The polymeric material of the present invention possesses otherwise similar properties compared to their non-conductive counter polymers. The current invention thereby provides a solution to the problems described above and provides a conductive biodegradable polymer material with otherwise sustained or improved properties compared to non-conductive polymer materials. The objects of the invention are achieved by a polymer composition and method to produce the polymer composition which are characterized by what is stated in the independent claims. The preferred embodiments of the invention are disclosed in the dependent claims.

The current invention thereby provides a method for producing a polymer composite, wherein the method comprises the following steps:

a) providing at least one monomer capable of forming a poly(hydroxy carboxylic acid);

b) providing a graphene nano-filler;

c) mixing the monomer capable of forming a poly(hydroxy carboxylic acid) and the graphene nano-filler;

d) optionally providing one or more component selected from a second monomer capable of forming a polymer, an adjuvant, an additive and a catalyst;

e) letting the monomer capable of forming a poly(hydroxy carboxylic acid) polymerize in the presence of the graphene nano-filler to form a polymer master batch

f) introducing the master batch into an extruder together with another polymer which is the same or different compared to the polymer in the master batch to form a polymer composite, wherein

the graphene nano-filler is a multi walled carbon nanotube (mwcnt) or a single wall carbon nanotube (swcnt), preferably a single wall carbon nanotube, and content of the graphene nano-filler in the formed polymer composite is from 0.3 wt-% to 0.001 wt-% and preferably from 0.1 wt-% to 0.01 wt-%.

The current invention also provides a polymer composite comprising a biodegradable poly(hydroxy carboxylic acid) and a graphene nano-filler, which imparts electric conductivity to the polymer composite, where the amount of graphene nano-fillers in the polymer composite is from 0.3 wt-% to 0.001 wt-%, preferably from 0.1 wt-% to 0.001 wt-% and more preferably from 0.05 wt-% to 0.01 wt-% and the graphene nano-filler is a multi walled carbon nanotube (mwcnt) or a single wall carbon nanotube (swcnt), preferably a single wall carbon nanotube.

The conductive polymers of the present invention can be used in various fields such as electromagnetic interference (EMI) shielding, radio frequency interference (RFI) shielding, electrostatic discharge ESD and antistatic protection. Using conductive polymers for EMI, RFI, and EDS shielding provides weight reduction, reduced manufacturing steps and thereby reducing costs. Conductive polymers and materials according to the present invention find also potential applications in regenerative medicine were cells/tissue sensitive to electrical signals are applied or to be repaired.

### DETAILED DESCRIPTION OF THE INVENTION

The current invention provides a polymer composition and a method for producing a master batch and a polymer composite. The polymer composition according to the invention is made conductive by incorporating graphene nano-fillers into the polymer composition. The graphene nano-fillers are known to impart conductivity to polymer composites. The invention is based on the finding that graphene nano-fillers can impart conductivity in poly(hydroxy carboxylic acid)s at a concentration from 1 wt %, preferably 0.3 wt % and more preferably from 0.1 wt-% to as low as 0.01 wt % or even to 0.001 wt % of total polymer composite. The invention is based on the finding that a very low concentration of graphene nano-fillers can be incorporated into a master batch and further to a polymer composition using an in situ polymerisation of the master batch. The poly(hydroxy carboxylic acid) is formed (polymerisation reaction) in the presence of the graphene nano-fillers to form a master batch.

The in situ polymerisation of the poly(hydroxy carboxylic acid) in the presence of graphene nano-fillers provides a master batch where the graphene nano-fillers have an improved distribution and dispersion in the polymer. This improved distribution and dispersion of the graphene nano-fillers in the polymer compared to polymers, where the nano-fillers have been mixed or blended in the melted polymer, provided significantly improved over all properties. Sufficient conductivity can be reach with very low amount of nano-fillers and the low amount does not infer with the other properties of the poly(hydroxy carboxylic acid). Therefore, the invention provides a method to impart conductivity to poly(hydroxy carboxylic acid)s using fillers without the need to compromise on any other properties of the polymer composition.

The in situ polymerised master batch is then further blended with a polymer, which does not contain graphene nano-fillers, to produce the final polymer composition with the final graphene nano-filler concentration. Blending of the graphene nano-filler containing master batch with the polymer can preferably be performed in an extruder. The blending of the master batch and the polymer can be with the same polymer as the master batch or with a different polymer. Blending the master batch with graphene nano-filler with another polymer provides a homogenous distribution of the graphene nano-filler is the polymer composition, which enhances the conductivity of the polymer composite. It was surprisingly found that by mixing e.g. a master batch with PLLA+graphene nano-tubes and PLLA or PBS provided a polymer composition with enhanced conductivity, even with low concentrations of graphene nano-fillers in the formed polymer composite.

The term “polymer composite” as used herein describe a composite of at least one basic polymer, such as a poly(hydroxy carboxylic acid) with at least one other component, such as a graphene nano-filler blended with a another polymer. Polymer composites can be any material formed from a polymer and another component, which provides properties to the material, which the polymer itself does not possess, thereby enhancing the properties of the material.

The term “a monomer capable of forming a poly(hydroxy carboxylic acid) as used herein describe any organic molecule or mixture of two or more organic molecules, which can be polymerised to form a poly(hydroxy carboxylic acid). The monomer capable of forming a poly(hydroxy carboxylic acid) can be a single monomer when the formed polymer will be a homopolymer. The monomer can also be a mixture of two or more monomers when the formed polymer will be a co-polymer of two or more different monomers forming the repeating units of the polymer.

The term “poly(hydroxy carboxylic acid)” is here meant to include polyesters formed by polycondensation through the reaction between a diol and a dicarboxylic acid, such as but not limited to poly(butylene succinate) (PBS) and poly(butylene-succinate-adipate) (PBAT).

The monomer or the mixture of monomers need to comprise at least one hydroxyl group and one carboxylic acid groups, which can react forming an ester bond. The ester bond forms the linkage between the repeating units of the poly(hydroxy carboxylic acid) and is therefore part of the polymer backbone. The polymer backbone can also include side chains depending on the chemical structure of the monomer.

The monomer capable of forming a poly(hydroxy carboxylic acid) originates preferably from renewable sources, such as corn and rice or other sugar- or starch producing plants. When monomers from renewable sources are used the polymer composite can be described as a sustainable renewable polymer composite. In case of poly(hydroxy carboxylic acid) the polymer is also biodegradable and the carbon footprint of the polymer composite is therefore substantially lower than polymers that are fossil-based. The biodegradation provides an alternative for end-of-life and recycling for the polymers. The biodegradation secures the degradation of the polymer into harmless water and carbon dioxide if e.g. the polymer accidentally is released into the environment. Since the monomers are of renewable (plant) origin the degradation into carbon dioxide will not increase the carbon footprint.

In one embodiment of the invention the monomer capable of forming a poly(hydroxy carboxylic acid) is a single monomer and selected from the group of lactic acid, lactide, caprolactone, glycolic acid, glycolide, 3-hydroxybutyric acid, 4-hydroxybutyric acid, 4-hydroxyvaleric acid, 5-hydroxyvaleric acid, 6-hydroxycaprioic acid, β-propiolactone, β-butyrlactone, γ-butyrlactone, γ-valerolactone, δ-valerolactone and ε-caprolactone.

In one embodiment of the invention the monomer capable of forming a poly(hydroxy carboxylic acid) is a mixture of monomers and selected from the mixtures of succinic acid and 1,4-butanediol or adipic acid, 1,4-butanediol and terephtalic acid.

In one embodiment of the invention the monomer capable of forming a poly(hydroxy carboxylic acid) is selected from lactic acid, lactone, caprolactic acid, caprolactone, glycolic acid and a mixture of succinic acid and 1,4-butanediol or a mixture of adipic acid, 1,4-butanediol and terephtalic acid. These monomers forms poly(lactic acid), poly(caprolactic acid), poly(glycolic acid), poly(butylene succinic acid) and poly(butylene adipate terephthalate respectively. These polymers can also be abbreviated PLA, PCL, PGA, PBS and PBAT respectively.

In one embodiment of the invention the monomer is lactic acid or lactone that forms poly(lactic acid) or PLA. Poly(lactic acid) can be formed by polycondensation polymerisation of the lactic acid or by a ring opening polymerisation (ROP) of lactone. Lactone is a cyclic dimer of lactic acid. Lactic acid has a chiral centre and the lactic acid can be in the form of L- or D-lactic acid. If the polymer is produced using L-lactic acid the polymer can be called poly L-lactic acid or PLLA.

The formation of PLA and the various polymerisation reactions are well known in the literature and the current invention is not restricted to any particular polymerisation reaction.

In one embodiment of the invention the polymer in the polymer composite is polymerised to a molecular weight of up to 150 000 g/mol (Dalton, Da), preferably up to 100 000 g/mol, more preferably 50 000 g/mol.

The term “graphene nano-fillers” used herein refers to any component essentially made of graphene and having a nano scale material structure. Graphene refers to a single layer of carbon atoms densely packed into a fused benzene-ring structure. The term “nano-fillers” refers that they are used in the polymer composite as filling material to be used for reinforcement of the polymers, especially for imparting conductivity to the polymer composite. The nano-fillers of the invention are particles in the nano-scale, i.e. from 1 to 100 nanometers.

In one embodiment of the invention the graphene nano-fillers are selected from the group of carbon nanotubes, graphite nanoparticles, graphene nanoparticles and fullerene nanoparticles. Carbon nanotubes is a collective term for carbon allotropes with a cylindrical nanostructure, where at least one dimension of the particle is in the nano-scale. The carbon nanotubes are members of the fullerene structural family and can be categorized as single walled carbon nanotubes (swcnt) and multi walled carbon nanotubes (mwcnt). In the current invention single walled carbon nanotubes are preferred as graphene nano-fillers.

Graphene nano-fillers, such as carbon nanotubes are known to impart electrical and thermal conductivity to polymers when the polymers are reinforced with fibers of graphene. Carbon nanotubes have extremely high thermal and electrical conductivity and reinforcing polymers with carbon nanotubes provided polymers with improved electrical and thermal conductivity.

Thus, in one embodiment the invention concerns a method for producing a polymer master batch, wherein the method comprises the following steps:

a) providing at least one monomer capable of forming a poly(hydroxy carboxylic acid);

b) providing a graphene nano-filler;

c) mixing the monomer capable of forming a poly(hydroxy carboxylic acid) and the graphene nano-filler;

d) optionally providing one or more component selected from a second monomer capable of forming a polymer, an adjuvant, an additive and a catalyst;

e) letting the monomer capable of forming a poly(hydroxy carboxylic acid) polymerize in the presence of the graphene nano-filler to form a polymer master batch.

In an embodiment the master batch formed in step e) is further introduced into an extruder together with another polymer which is the same or different compared to the polymer in the master batch to form a polymer composite.

In an embodiment the monomer capable of forming a poly(hydroxy carboxylic acid) is a single monomer providing a homopolymer or a mixture of two or more monomers providing a co-polymer.

In an embodiment the monomer capable of forming a poly(hydroxy carboxylic acid) is a single monomer and selected from the group of lactic acid, lactide, caprolactone, glycolic acid, glycolide, 3-hydroxybutyric acid, 4-hydroxybutyric acid, 4-hydroxyvaleric acid, 5-hydroxyvaleric acid, 6-hydroxycaprioic acid, β-propiolactone, β-butyrlactone, γ-butyrlactone, γ-valerolactone, δ-valerolactone and ε-caprolactone or the monomer is a mixture of monomers selected from the mixtures of succinic acid and 1,4-butanediol; adipic acid, 1,4-butanediol and terephtalic acid.

In an embodiment the graphene nano-filler is selected from the group of carbon nanotubes, graphite nanoparticles, graphene nanoparticles, fullerene nanoparticles and any mixture thereof.

In an embodiment the graphene nano-filler is a multi walled carbon nanotube (mwcnt) or a single wall carbon nanotube (swcnt), preferably a single wall carbon nanotube.

In an embodiment the monomer capable of forming a poly(hydroxy carboxylic acid) is provided in liquid form.

In an embodiment the monomer is L-lactide or lactic acid forming poly(lactic acid) and the graphene nano-filler is a single wall carbon nanotube.

In an embodiment the content of the graphene nano-filler in the formed master batch is from 1.3 wt % to 2 wt %, preferably about 1.5 wt %.

In an embodiment the content of the graphene nano-filler in the formed polymer composite is from 1 wt % to 0.001 wt %, preferably from 0.3 wt % to 0.001 wt % and more preferably from 0.1 wt-% to 0.01 wt-%.

In an embodiment the invention relates to a polymer composite comprising a biodegradable poly(hydroxy carboxylic acid) and a graphene nano-filler, which imparts electric conductivity to the polymer composite, where the amount of graphene nano-fillers in the polymer composite is from 0.3 wt-% to 0.001 wt-%, preferably from 0.1 wt-% to 0.001 wt-% and more preferably from 0.05 wt-% to 0.01 wt-%.

In an embodiment the graphene nano-filler of the polymer composite is selected from the group of carbon nanotubes, graphite nanoparticles, graphene nanoparticles, fullerene nanoparticles and any mixture thereof.

In an embodiment the graphene nano-filler of the polymer composite is a multi walled carbon nanotube (mwcnt) or a single wall carbon nanotube (swcnt), preferably a single wall carbon nanotube.

In an embodiment the poly(hydroxy carboxylic acid) of the polymer composite is a poly(lactic acid), poly(caprolactic acid), poly(glycolic acid), poly(butylene succinate) or poly(butylene-adipate-terephthalate).

In an embodiment the poly(hydroxy carboxylic acid) of the polymer composite is poly(lactic acid) and the graphene nano-filler is a single wall carbon nanotube.

In an embodiment the polymer composite is manufactured by a method according to the invention.

In a further embodiment the invention relates to a polymer material comprising at least a polymer composite according to the invention and optionally a second biodegradable polymer and additives selected from, dyes, plasticizers, antistatic agents, extenders, flame retardants, heat stabilisers, pigments and a mixture thereof.

One embodiment of the invention relates to a use of polymer composite according to the invention or a polymer material according to the invention, to form strands, fibers or pellets, which can be formed into a blown film, cast film or moulded into a suitable object.

In one embodiment the use of polymer composite according to the invention or a polymer material according to the invention is as raw material in 3-D printing.

A further embodiment of the invention relates to a composite material comprising a polymer composite, which contains a concentration of graphene nano-fillers in a concentration from 1 wt % to 0.001 wt % and another component selected from wollastonite, talc, mica, graphene, graphite, degradable glass fiber and any mixture thereof.

In one embodiment the graphene nano-filler of the composite material is selected from carbon nanotubes, graphite nanoparticles, graphene nanoparticles, fullerene nanoparticles and any mixture thereof.

In one embodiment the graphene nano-filler of the composite material is a multi walled carbon nanotube (mwcnt) or a single wall carbon nanotube (swcnt), preferably a single wall carbon nanotube.

In one embodiment the polymer of the polymer composite of the composite material is a poly(hydroxy carboxylic acid) polymer.

In one embodiment the polymer of the polymer composite of the composite material is a poly(lactic acid), poly(caprolactic acid), poly(glycolic acid), poly(butylene succinate) or poly(butylene-adipate-terephthalate).

In one embodiment the said another component is degradable glass fiber.

In one embodiment the polymer composite containing graphene nano-filler is produced by the method according to the invention.

In one embodiment the composite material according to the invention is used in 3-D printing.

### EXAMPLES

### Example 1

Masterbatch Preparation

A 1.5 wt % masterbatch of single wall carbon nanotubes (swcnt) on PLLA carrier is prepared. L-Lactide (1477 g) and 23 g of swcnt are dry-mixed and fed to a heated (110° C.) steel reactor equipped with vacuum and nitrogen inlet. After 15-20 min, when the L-lactide has molten and blended with swcnt, the temperature is raised to 180° C. and the catalyst/co-initiator (stannous octoate/decanol) is injected. The reaction continues for 20-30 min and the heating is removed. The material (PLLA-based swcnt masterbatch) obtained from the reactor vessel is grinded to a size suitable for compounding and is used without any purifications.

Compounding of the Final Material with Low Concentration of swcnt to Form the Polymer Composite

The PLLA-based swcnt masterbatch material is fed into a double screw extruder and compounded with neat PLLA to achieve a final compound with a swcnt content of 0.001-0.3% wt % polymer composition. The compound is formed into strands (or alternatively directly using an underwater pelletizer) and chopped into pellets for further compression molded film, cast film and injection moulding purposes.

Alternatively, the PLLA-based SWCNT masterbatch material is fed into a double screw extruder and compounded with neat PBS to achieve a final swcnt content of 0.001-0.3 wt % polymer composition. The compound is formed into strands and chopped into pellets for further compression molded film, cast and injection moulding purposes.

To the double screw extruder also other chosen additives, e.g. nucleator, impact modifier, stabilizer or some mineral filler etc. can be added to prepare the final polymer composition.

### Example 2

Extruded Strand

The chosen PLLA-base polymer was melt mixed with PLLA-SWCNT master batch (to obtain final swcnt concentrations from (0.05 wt %) in a mini-double screw compounder for 60 seconds. The material was released from the compounder as a continuous strand. The measured resistivity for a final product with 0.05 wt % swcnt was 1×10¹⁰ Ohms (as measured with a Fluke 115 TRMS Digital Multimeter without any attempts to reduce the contact resistance effect).

Compression Molded Film

Pellets from the large-scale compounding experiments or the strands from the mini-compounding experiments were compression molded into film at 185° C. between two heat-resistant plastic foils. The applied time and pressure adopted afforded films of thickness between 50-150 microns. A PBS-base material was mixed with the PLLA-SWCNT masterbatch to reach a final swcnt concentration of 0.05 wt % swcnt and the film showed a surface resistivity of 5.5×10⁶ Ohm/square (as measured with a Quick 499, resistivity meter). Results are shown in table 1 below.

In the last two rows of Table 1 the polymer composition (PLA strand with 0.05 wt % and 0.3 wt % swcnt) was mixed with degradable glass fiber (ABM SGF) at a concentration of 20%.

TABLE 1
Measured resistivity (Ohms/square and Ohms) for
compression molded films and extruded strands.

| | Compresssion molded | Extruded strand |
|---|---|---|
| Material | film [Ohms/square] | Ohms |
| PLLA 0.05% CNT | 5.5 × 10⁸ | 1 × 10¹¹ |
| PLLA 0.1% CNT | 2 × 10⁶ | 1 × 10¹¹ |
| PLLA 0.3% CNT | 3.5 × 10³ | 1 × 10⁷ |
| PBS 0.05% CNT | 1 × 10⁸ | — |
| PBS 0.1% CNT | 1 × 10⁶ | — |
| PLA strand 0.05% CNT + | 1 × 10¹⁰ | 1 × 10¹¹ |
| ABM SGF 20% | | |
| PLA strand 0.3% CNT + | 3 × 10³ | 7.4 × 10⁴ |
| ABM SGF 20% | | |

### Example 3

The mechanical properties of the polymer composite (PLLA with 0.05 wt % and 0.1 wt % swcnt) was also tested and compared to PLLA without carbon nanotube fillers (PLLA REF). The results of the mechanical testing are shown in table 2.

TABLE 2
Mechanical properties of PLLA filled with swcnt

| | | Tensile | Strain | | Impact | Impact |
|---|---|---|---|---|---|---|
| | Tensile | strength | at | Young's | unnotched | notched |
| | strength | at break | break | modulus | Izod | Izod |
| | MPa | MPa | % | MPa | KJ/m² | KJ/m² |
| PLLA REF | 50 | 42 | 18.1 | 3566 | 82 | 20 |
| PLLA 0.05% CNT | 48 | 38 | 14.9 | 3578 | 112 | 26 |
| PLLA 0.1% CNT | 48 | 38 | 17.6 | 3623 | 104 | 26 |

From the results shown in table 2 it can be seen that the mechanical properties of the PLLA polymer is retained with a 0.05 wt % and 0.1 wt % carbon nanotube filling. However, the low amount of swcnt improves the impact resistance of the reference PLLA.

It will be obvious to a person skilled in the art that, as the technology advances, the inventive concept can be implemented in various ways. The invention and its embodiments are not limited to the examples described above but may vary within the scope of the claims.

1.-20. (canceled)

21. A method for producing a polymer composite, the method comprising:
a) providing at least one monomer capable of forming a poly(hydroxy carboxylic acid);
b) providing a graphene nano-filler;
c) mixing the monomer capable of forming a poly(hydroxy carboxylic acid) and the graphene nano-filler;
d) optionally providing one or more component selected from a second monomer capable of forming a polymer, an adjuvant, an additive and a catalyst;
e) letting the monomer capable of forming a poly(hydroxy carboxylic acid) polymerize in the presence of the graphene nano-filler to form a polymer master batch;
f) introducing the master batch into an extruder together with another polymer which is the same or different compared to the polymer in the master batch to form a polymer composite, wherein
the graphene nano-filler is a multi walled carbon nanotube (mwcnt) or a single wall carbon nanotube (swcnt), preferably a single wall carbon nanotube, and content of the graphene nano-filler in the formed polymer composite is from 0.3 wt-% to 0.001 wt-% and preferably from 0.1 wt-% to 0.01 wt-%.

22. The method according to claim 21, wherein the monomer capable of forming a poly(hydroxy carboxylic acid) is a single monomer providing a homopolymer or a mixture of two or more monomers providing a co-polymer.

23. The method according to claim 21, wherein the monomer capable of forming a poly(hydroxy carboxylic acid) is a single monomer and selected from the group of lactic acid, lactide, caprolactone, glycolic acid, glycolide, 3-hydroxybutyric acid, 4-hydroxybutyric acid, 4-hydroxyvaleric acid, 5-hydroxyvaleric acid, 6-hydroxycaprioic acid, β-propiolactone, β-butyrlactone, γ-butyrlactone, γ-valerolactone, δ-valerolactone and ε-caprolactone or the monomer is a mixture of monomers selected from the mixtures of succinic acid and 1,4-butanediol or adipic acid, 1,4-butanediol and terephtalic acid.

24. The method according to claim 21, wherein the monomer capable of forming a poly(hydroxy carboxylic acid) is provided in liquid form.

25. The method according to claim 21, wherein the monomer is L-lactide or lactic acid forming poly(lactic acid) and the graphene nano-filler is a single wall carbon nanotube.

26. A polymer composite comprising a biodegradable poly(hydroxy carboxylic acid) and a graphene nano-filler, which imparts electric conductivity to the polymer composite, wherein the amount of graphene nano-fillers in the polymer composite is from 0.05 wt-% to 0.001 wt-% and the graphene nano-filler is a multi walled carbon nanotube (mwcnt) or a single wall carbon nanotube (swcnt), preferably a single wall carbon nanotube.

27. The polymer composite according to claim 26, wherein the poly(hydroxy carboxylic acid) is a poly(lactic acid), poly(caprolactic acid), poly(glycolic acid), poly(butylene succinate) or poly(butylene-adipate-terephthalate).

28. The polymer composite of claim 26, wherein the poly(hydroxy carboxylic acid) is poly(lactic acid) and the graphene nano-filler is a single wall carbon nanotube.

29. The polymer composite of claim 26, wherein the polymer composite is manufactured by at least:
a) providing at least one monomer capable of forming a poly(hydroxy carboxylic acid);
b) providing a graphene nano-filler;
c) mixing the monomer capable of forming a poly(hydroxy carboxylic acid) and the graphene nano-filler;
d) optionally providing one or more component selected from a second monomer capable of forming a polymer, an adjuvant, an additive and a catalyst;
e) letting the monomer capable of forming a poly(hydroxy carboxylic acid) polymerize in the presence of the graphene nano-filler to form a polymer master batch;
f) introducing the master batch into an extruder together with another polymer which is the same or different compared to the polymer in the master batch to form a polymer composite, wherein
the graphene nano-filler is a multi walled carbon nanotube (mwcnt) or a single wall carbon nanotube (swcnt), preferably a single wall carbon nanotube, and content of the graphene nano-filler in the formed polymer composite is from 0.3 wt-% to 0.001 wt-% and preferably from 0.1 wt-% to 0.01 wt-%.

30. A polymer material comprising at least a polymer composite according to claim 26 and optionally a second biodegradable polymer and additives selected from, dyes, plasticizers, antistatic agents, extenders, flame retardants, heat stabilisers, pigments and a mixture thereof.

31. A composite material comprising a polymer composite, which contains a concentration of graphene nano-fillers in a concentration from 0.3 wt % to 0.001 wt % and another component selected from wollastonite, talc, mica, graphene, graphite, degradable glass fiber and any mixture thereof, and wherein the polymer composite containing graphene nano-filler is produced by at least:
a) providing at least one monomer capable of forming a poly(hydroxy carboxylic acid);
b) providing a graphene nano-filler;
c) mixing the monomer capable of forming a poly(hydroxy carboxylic acid) and the graphene nano-filler;
d) optionally providing one or more component selected from a second monomer capable of forming a polymer, an adjuvant, an additive and a catalyst;
e) letting the monomer capable of forming a poly(hydroxy carboxylic acid) polymerize in the presence of the graphene nano-filler to form a polymer master batch;
f) introducing the master batch into an extruder together with another polymer which is the same or different compared to the polymer in the master batch to form a polymer composite, wherein
the graphene nano-filler is a multi walled carbon nanotube (mwcnt) or a single wall carbon nanotube (swcnt), preferably a single wall carbon nanotube, and content of the graphene nano-filler in the formed polymer composite is from 0.3 wt-% to 0.001 wt-% and preferably from 0.1 wt-% to 0.01 wt-%.
